(19) United States
(12) Patent Application Publication
(10) Pub. No.: US 2017/0167426 A1
(43) Pub. Date: Jun. 15, 2017

(54) METHOD AND SYSTEM FOR CONTROLLING MOTOR OF FUEL PUMP

(71) Applicant: HYUNDAI MOTOR COMPANY, Seoul (KR)

(72) Inventors: Sang Hyun JANG, Yongin-si (KR); Hee Jun LEE, Seoul (KR); Sun Woo KIM, Seoul (KR)

(21) Appl. No.: 15/220,054

(22) Filed: Jul. 26, 2016

(30) Foreign Application Priority Data
Dec. 11, 2015 (KR) 10-2015-0177233

(51) Int. Cl. F02D 41/30

(52) U.S. Cl. CPC F02D 41/3082

(57) ABSTRACT

A method for controlling a motor of a vehicle fuel pump includes a duty calculation step of calculating, by a motor controller, a duty value of the motor to satisfy a hydraulic pressure of fuel required in accordance with a travel situation of the vehicle, receiving the duty value calculated by the motor controller at the duty calculation step, and determining, by the monitoring unit, whether or not the received duty value is lower than a critical value set in the monitoring unit, and a forced driving step of preventing, by the monitoring unit, a duty value signal from the motor controller from being sent to the motor and directly connecting the motor to a power source, thereby forcibly driving the motor to generate power at a predetermined level when the monitoring unit determines that the duty value calculated by the motor controller is lower than the critical value.

### CROSS-REFERENCE TO RELATED APPLICATION

This application claims the benefit of priority to Korean Patent Application No. 10-2015-0177233, filed on Dec. 11, 2015 with the Korean Intellectual Property Office, the disclosure of which is incorporated herein by reference.

### TECHNICAL FIELD

The present disclosure relates to a method and system for controlling a motor of a fuel pump, and more particularly to a method and system for controlling a motor of a vehicle fuel pump, which are capable of preventing supply of a fuel to a vehicle engine from being cut off even in an abnormal state of the motor of the fuel pump.

### BACKGROUND

Fuel is injected into a combustion chamber of an engine via an injector after being supplied from a fuel tank. The amount of fuel supplied to the engine is determined in accordance with various conditions of the vehicle, such as travel speed and required engine torque.

A fuel pump is provided at the fuel tank in order to generate hydraulic pressure, causing fuel to be pumped from the fuel tank to the engine. A motor is included in the fuel pump in order to supply a drive power for generation of the fuel pressure.

Meanwhile, when no fuel is supplied from the fuel tank to the engine during driving of the engine, the engine cannot generate drive power for the vehicle and, as such, travel of the vehicle is impossible. In this regard, it is important for the motor of the fuel pump for the fuel tank to be always in a driven state to ensure an adequate supply of fuel to the engine.

The above matters disclosed in this section are merely for enhancement of understanding of the general background of the disclosure and should not be taken as an acknowledgement or any form of suggestion that the matters, or concepts disclosed in this disclosure, form the related art already known to a person skilled in the art.

### SUMMARY

Therefore, the present disclosure has been made in view of the above problems, and it is an object of the present disclosure to provide a method and system for controlling a motor of a fuel pump in a vehicle, which are capable of securing supply of fuel to an engine even in an abnormal state of the motor of the fuel pump, to enable normal travel of the vehicle.

In accordance with the present disclosure, the above and other objects can be accomplished by the provision of a method for controlling a motor of a vehicle fuel pump including a duty calculation step of calculating, by a motor controller, a duty value of the motor to satisfy a hydraulic pressure of fuel required in accordance with a travel situation of the vehicle, a critical state determination step of receiving, by a monitoring unit, the duty value calculated by the motor controller at the duty calculation step, and determining, by the monitoring unit, whether or not the received duty value is lower than a critical value set in the monitoring unit, and a forced driving step of preventing, by the monitoring unit, a duty value signal from the motor controller from being sent to the motor and directly connecting the motor to a power source, by the monitoring unit, thereby forcibly driving the motor to generate power of a predetermined level when the monitoring unit determines at the critical state determination that the duty value calculated by the motor controller is lower than the critical value.

The method may further include a motor driving step of sending the duty value signal from the motor controller to the motor by the monitoring unit, thereby driving the motor at the duty value calculated by the motor controller, when the monitoring unit determines at the critical state determination step that the calculated duty value is equal to or higher than the critical value.

during the duty calculation step, the motor controller may receive, from the engine controller, information as to an amount of fuel to be consumed in a current travel situation of the vehicle, and may calculate a duty value of the motor to satisfy a hydraulic pressure of fuel required in the current travel situation of the vehicle based on the received information and a current hydraulic pressure of fuel.

In accordance with another aspect of the present disclosure, there is provided a system for controlling a motor of a vehicle fuel pump including a motor controller for calculating a duty value of the motor to satisfy a hydraulic pressure of fuel required in accordance with a travel situation of the vehicle, and a monitoring unit for determining whether or not the duty value calculated by the motor controller is lower than a predetermined critical value, and preventing a duty value signal from the motor controller from being sent to the motor while directly connecting the motor to the power source, thereby forcibly driving the motor to generate power of a predetermined level, when the calculated duty value is lower than the predetermined critical value.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart illustrating a method for controlling a motor of a vehicle fuel pump in accordance with an embodiment of the present disclosure; and

FIG. 2 is a block diagram illustrating a system for controlling a motor of a vehicle fuel pump in accordance with an embodiment of the present disclosure.

### DETAILED DESCRIPTION

Reference will now be made, in detail, to embodiments of the present disclosure, examples of which are illustrated in the accompanying drawings. Wherever possible, the same reference numbers will be used throughout the drawings to refer to the same or like parts.

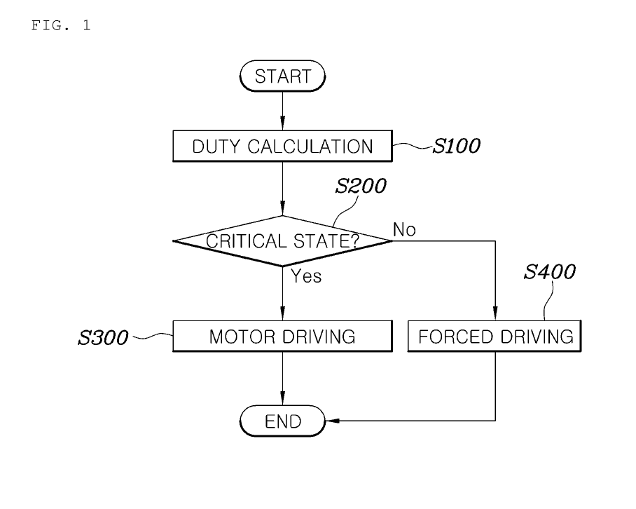

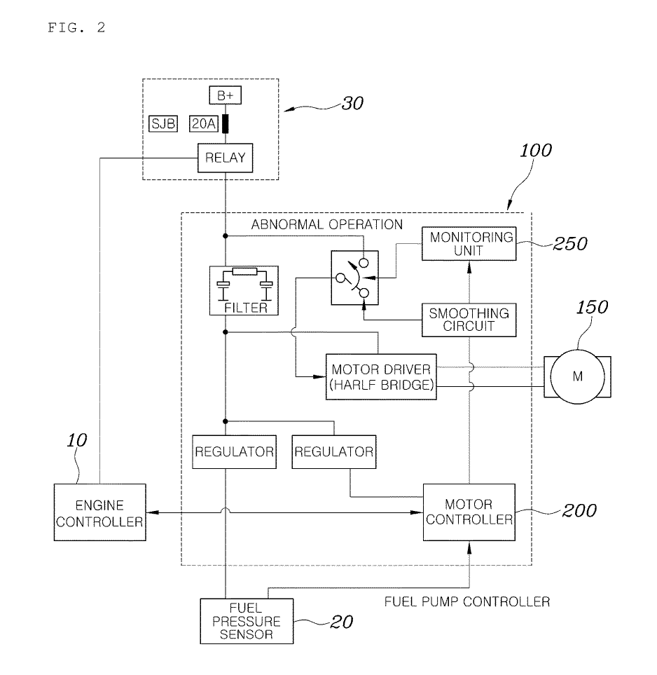

Referring to FIGS. 1 and 2, a method for controlling a motor of a vehicle fuel pump in accordance with an embodiment of the present disclosure is illustrated. As illustrated in FIGS. 1 and 2, the motor control method may include a duty calculation S100 of calculating, by a motor controller 200, a duty value of a motor 150 to satisfy a hydraulic pressure of fuel required in accordance with a travel situation of the vehicle, and a critical state determination S200 of receiving, by a monitoring unit 250, the duty value calculated by the motor controller 200 at the duty calculation S100, and determining, by the monitoring unit 250, whether or not the received duty value is lower than a critical value set in the monitoring unit 250. The motor control method also may include a forced driving S400 of preventing, by the monitoring unit 250, a duty value signal from the motor controller 200 from being sent to the motor 150 and directly connecting the motor 150 to a power source 30, by the monitoring unit 250. This may forcibly drive the motor 150 to generate power of a predetermined level when the monitoring unit 250 determines at the critical state determination S200 that the duty value calculated by the motor controller 200 is lower than the critical value.

Such a process will be described in detail. At the duty calculation S100, the motor controller 200 may calculate a duty value of the motor 150 to satisfy a hydraulic pressure of fuel required in accordance with a travel situation, or set of variables, of the vehicle.

In a situation in which high output power from the engine is required due to high-speed travel of the vehicle or the like, the amount of fuel introduced into the engine may be increased. In such a situation, the fuel pump may require increased drive power in order to generate a satisfactory hydraulic pressure of fuel to be injected from an injector.

Conversely, in a situation in which low output power from the engine is required due to low-speed travel of the vehicle or travel of the vehicle on a downhill road, the amount of fuel injected from the injector may be reduced and, as such, drive power consumed by the fuel pump to generate a satisfactory hydraulic pressure of fuel may be reduced.

Electric power consumption of the motor 150 of the fuel pump to generate a hydraulic pressure of fuel required during fuel injection of the injector may be varied in accordance with travel situations, or vehicle variables, of the vehicle, as mentioned above. In connection with this, maintenance of the motor 150 in a constant driving state may be inefficient in that consumption of electric power may be unnecessarily increased, or it may be impossible to immediately satisfy requirements to cope with travel situations of the vehicle.

To this end, the motor controller 200 may determine a duty value of the motor 150 to satisfy a hydraulic pressure of fuel required for the engine in accordance with a travel situation of the vehicle, and may drive the motor 150, based on the determined duty value. That is, the motor controller 200 may increase the duty value of the motor 150 in a situation requiring high output power from the engine to generate a satisfactory hydraulic pressure of fuel. On the other hand, in a situation requiring low output power from the engine, the motor controller 200 may reduce the duty value of the motor 150, to prevent unnecessary energy consumption.

Meanwhile, at the critical state determination S200, the monitoring unit 250 may receive the duty value calculated by the motor controller 200 at the duty calculation S100, and determine whether or not the received duty value is lower than a critical value set in the monitoring unit 250.

Even in a situation requiring low output power from the engine, the duty value of the motor 150 may have at least a minimum value, taking into consideration flow resistance of fuel, driving resistance of the motor 150, etc. The minimum duty value may be defined as a critical value in the present disclosure.

The critical value may be determined in accordance with various factors, for example, the kind of the motor 150, the design of fuel flow lines, etc. When the duty value of the motor 150 is lower than the critical value, driving of the engine may be stopped because the motor 150 cannot generate a hydraulic pressure of fuel required for the engine even though driving of the motor 150 is continued without being stopped.

Meanwhile, the motor controller 200 may be equipped with a communication unit to communicate with an engine controller 10, to receive information as to hydraulic pressure of the fuel. When failure of communication between the motor controller 200 and the engine controller 10, failure of the communication unit, or failure of the motor controller 200 occurs, there may be a situation where the duty value determined for driving of the motor 150 may be lower than the critical value.

Such an abnormal state of the fuel pump may be caused by the motor controller 200 itself. To this end, the monitoring unit 250, which may be configured to operate independently of the motor controller 200, may measure the duty value of the motor 150, and determine whether or not the measured duty value is lower than the critical value. Accordingly, it is possible to determine whether or not the duty value of the motor 150 is lower than the critical value, even in a state in which communication failure or failure of the motor controller 200 has occurred.

The monitoring unit 250 may have various configurations, and the monitoring unit 250 may be independent of the motor controller 200 in terms of operation. For example, the monitoring unit 250 may be separate from the motor controller 200. Alternatively, the motor controller 200 may include a plurality of control units each configured to achieve independent calculations such that a selected one of the control units is used as the monitoring unit 250.

The monitoring unit 250 may determine whether or not an abnormal state of the motor 150 has occurred by determining whether or not the duty value of the motor 150 sent from the motor controller 200 to a motor driver is lower than the critical value previously input to the monitoring unit 250.

Meanwhile, at the forced driving S400, the monitoring unit 250 may prevent a duty value signal from the motor controller 200 from being sent to the motor 150 when the monitoring unit 250 determines, at the critical state determination S200, that the duty value calculated by the motor controller 200 is lower than the critical value. In this case, the monitoring unit 250 may directly connect the motor 150 to the power source 30, to cause the motor 150 to be driven at a maximum power.

When the duty value of the motor 150 determined by the motor controller 200 is lower than the critical value, as described above, normal supply of fuel to the engine may not be able to be achieved and, as such, this state may be determined to be an abnormal state of the motor 150.

In order to supply fuel to the injector of the engine through normal operation of the fuel pump even in the above-described situation, the monitoring unit 250 may prevent a duty value signal from the motor controller 200 from being sent to the motor 150, and directly may connect the motor 150 to the power source 30. The monitoring unit 250 may activate a switch provided at a control circuit, thereby disconnecting the motor controller 200 from the motor 150 while directly connecting the motor 150 to the power source 30.

When the motor 150 (in detail, the motor driver) is directly connected to the power source 30, the motor 150 may be forcibly driven to generate power of a predetermined level without requiring a separate control operation for adjustment of output power, which may be separate from the case in which the motor 150 is driven at a controlled duty value. The motor 150 may be forcibly driven at a maximum power while having a duty value of 100% by the power source 30. Accordingly, it may be possible to always satisfy a hydraulic pressure of fuel required for the engine, regardless of operations of the motor controller 200 to determine the duty value of the motor 150 to be at a level satisfying a hydraulic pressure of fuel currently required for the engine through calculation. Accordingly, normal travel of the vehicle may be achieved.

Meanwhile, as illustrated in FIGS. 1 and 2, the motor control method according to the illustrated embodiments of the present disclosure may further include motor driving S300 of sending the duty value signal from the motor controller 200 to the motor 150 by the monitoring unit 250, thereby driving the motor 150 at the duty value calculated by the motor controller 200 when the monitoring unit 250 determines at the critical state determination S200 that the calculated duty value is equal to or higher than the critical value.

That is, when the duty value of the motor 150 calculated by the motor controller 200, as represented by the duty value signal, is equal to or higher than the critical value set in the monitoring unit 250, the motor 150 may be controlled based on the duty value signal sent from the motor controller 200. Accordingly, the motor 150 may be driven at a level satisfying a hydraulic pressure of fuel required in the current travel situation, or set of variables, of the vehicle without unnecessary consumption of electric power.

Meanwhile, as illustrated in FIGS. 1 and 2, in accordance with the motor control method according to an illustrated embodiment of the present disclosure, at the duty calculation S100, the motor controller 200 may receive, from the engine controller 10, information as to an amount of fuel to be consumed in the current travel situation of the vehicle, and calculate a duty value of the motor 150 to satisfy a hydraulic pressure of fuel required in the current travel situation of the vehicle, based on the received information and the current hydraulic pressure of fuel.

In detail, the engine controller 10 may determine an injection amount of fuel (an amount of fuel to be consumed) required in accordance with the current travel situation of the vehicle. The motor controller 200 may receive information as to the amount of fuel to be consumed from the engine controller 10 via the communication unit provided as described above, may sense the current hydraulic pressure of fuel, and may calculate a duty value of the motor 150 to satisfy a hydraulic pressure of fuel required for the engine, based on the received information and the sensed hydraulic pressure of fuel.

That is, it may be possible to appropriately determine a driving degree of the fuel pump motor 150 to satisfy a hydraulic pressure of fuel required for the engine, taking into consideration the amount of fuel consumed by the engine in accordance with the current hydraulic pressure of fuel. Based on the determined driving degree, a required duty value of the motor 150 may be calculated.

Meanwhile, referring to FIG. 2, a system 100 for controlling a motor of a fuel pump in a vehicle in accordance with an embodiment of the present disclosure is illustrated. As illustrated in FIG. 2, the motor control system may include the motor controller 200, which may calculate a duty value of the motor 150 to satisfy a hydraulic pressure of fuel required in accordance with a travel situation of the vehicle, and the monitoring unit 250, which may determine whether or not the duty value calculated by the motor controller 200 is lower than a predetermined critical value, and may prevent a duty value signal from the motor controller 200 from being sent to the motor 150 while directly connecting the motor 150 to the power source 30, thereby forcibly driving the motor 150 to generate power of a predetermined level when the calculated duty value is lower than the predetermined critical value.

As described above, the motor controller 200 may be equipped with the communication unit to communicate with the engine controller 10. In addition, the motor controller 200 may be connected to a sensor 20 for sensing the current hydraulic pressure of fuel. The motor controller 200 may calculate a currently required duty value of the motor 150, based on information received from the engine controller 109 and the fuel pressure sensor 20.

In addition, the monitoring unit 250 may be configured to operate independently of the motor controller 200 and to achieve independent calculation. The monitoring unit 250 may monitor a duty value signal sent from the motor controller 200 to the motor 150, and determine whether or not the duty value represented by the duty value signal is less than the critical value.

When the duty value of the motor 150 is less than the critical value, the monitoring unit 250 may activate the switch provided at the control circuit, thereby disconnecting the motor controller 200 from the motor 150 while directly connecting the motor 150 to the power source 30. Accordingly, the motor 150 may be forcibly driven to generate power of a predetermined level (or, to generate a maximum power corresponding to a duty value of 100%). Accordingly, it may be possible to satisfy a hydraulic pressure of fuel required for the engine, even when the fuel pump cannot normally operate due to failure of the motor controller 200 or the like. Thus, normal travel of the vehicle may be achieved.

As is apparent from the above description, in accordance with the motor control method and system for an engine pump of a vehicle, it may be possible to secure a supply of fuel to the engine even during abnormal driving of the motor in the engine pump and, as such, normal travel of the vehicle may be achieved.

In particular, through determination of whether or not the duty value of the motor to satisfy an amount of fuel currently required in the vehicle is lower than the critical value, the motor may be forcibly driven in a situation in which a supply of fuel is substantially impossible and, as such, fuel can be supplied to the engine even in an abnormal state of the motor controller.

In addition, through direct connection of the motor to the power source in an abnormal state of the motor controller, the motor can be forcibly driven in spite of the abnormal state of the motor controller and, as such, fuel can be supplied to the engine. Thus, normal travel of the vehicle may be achieved.

Although embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method for controlling a motor of a vehicle fuel pump comprising:
a duty calculation step of calculating, by a motor controller, a duty value of the motor to satisfy a hydraulic pressure of fuel required in accordance with a travel situation of the vehicle;
a critical state determination step of receiving, by a monitoring unit, the duty value calculated by the motor controller at the duty calculation step, and determining, by the monitoring unit, whether or not the received duty value is lower than a critical value set in the monitoring unit; and
a forced driving step of preventing, by the monitoring unit, a duty value signal from the motor controller from being sent to the motor and directly connecting the motor to a power source, by the monitoring unit, thereby forcibly driving the motor to generate power at a predetermined level when the monitoring unit determines at the critical state determination step that the duty value calculated by the motor controller is lower than the critical value.

2. The method according to claim 1, further comprising:
a motor driving step of sending the duty value signal from the motor controller to the motor by the monitoring unit, thereby driving the motor at the duty value calculated by the motor controller, when the monitoring unit determines at the critical state determination that the calculated duty value is equal to or higher than the critical value.

3. The method according to claim 1, wherein, during the duty calculation step, the motor controller receives, from the engine controller, information as to an amount of fuel to be consumed in a current travel situation of the vehicle, and calculates a duty value of the motor to satisfy a hydraulic pressure of fuel required in the current travel situation of the vehicle, based on the received information and a current hydraulic pressure of fuel.

4. A system for controlling a motor of a vehicle fuel pump comprising:
a motor controller for calculating a duty value of the motor to satisfy a hydraulic pressure of fuel required in accordance with a travel situation of the vehicle; and
a monitoring unit for determining whether or not the duty value calculated by the motor controller is lower than a predetermined critical value, and preventing a duty value signal from the motor controller from being sent to the motor while directly connecting the motor to the power source, thereby forcibly driving the motor to generate power of a predetermined level when the calculated duty value is lower than the predetermined critical value.
